(19) United States
(12) Patent Application Publication
(10) Pub. No.: US 2009/0254211 A1
(43) Pub. Date: Oct. 8, 2009

(54) Device for adjusting the position of tools in an automatic lathe

(76) Inventor: Jean-Charles Monnin, Sonceboz-Sombeval (CH)

Correspondence Address: BACON & THOMAS, PLLC, 625 SLATERS LANE, FOURTH FLOOR, ALEXANDRIA, VA, 22314-1176, US

(21) Appl. No.: 11/991,068

(22) PCT Filed: Sep. 2, 2005
(86) PCT No.: PCT/CH2005/000524

§ 371 Date: May 2, 2008

(51) Int. Cl. G05D 3/00; B23B 7/00

(52) U.S. Cl. 700/186; 82/118

(57) ABSTRACT

The invention relates to a device for adjusting the position of cutting tools (5) or end tools (6) in relation to the central axis (1) of the guide bush (2) of an automatic lathe. The device according to the invention essentially comprises a miniature CCD camera (3) which is equipped with an extension tube (4) containing a gradient-index lens (9) and an achromatic lens (10). According to the invention, the extension tube (4) is introduced into the guide bush (2) and is maintained in place by the workholder of the headstock (28) which clamps a fixing end piece (27) which is in turn fixed to the camera housing (18). Once introduced into the guide bush, the assembly can be used to obtain an image of the tool through the opening of the guide bush. The tool to be position-adjusted is illuminated by a set of light-emitting diodes (16). The image is transmitted to a computer via a cable (8). The computer program can be used to create a pattern on the screen in the form of Cartesian co-ordinates which are centred around the axis (1) of the guide bush, to acquire the position of the tool in the co-ordinate system, to compare same to the position thereof in the system of the machine and, subsequently, to adjust the position of the tool taking account of the differences between the co-ordinates of the two systems.

### FIELD OF INVENTION

The present invention relates to the adjustment of the position of tools, whether cutting tools such as inserts, or end tools such as drills, relative to the central bore axis of the guide bush holding the workpiece, generally metal bar stock, on an automatic lathe, still called “décolleteuse”, with fixed or sliding headstock.

### PRIOR TECHNIQUE

Significant developments in automatic lathes, particularly automatic lathes with sliding headstocks, means that some very high performance machines now exist. These machines enable the turning of complex parts to increasingly tight dimensional and geometric tolerances. However, in order to achieve such accuracy, increasingly precise and reliable means for presetting the tool position are essential. These presetting configurations consist primarily of a measurement set-up comprising a mount which accepts the cutting tool with its tool holder, as well as comparators (contact type measurement) or a projector fitted with a measuring system (contactless measurement), which offer the possibility of defining and registering the coordinates from the tip of cutting tool or end tool within a plane (e.g. X, Y), or within a three-dimensional space (e.g. X, Y, Z).

However, alignment accuracy once the tool is installed in the machine is far from satisfactory. Alignment errors resulting from inaccuracies between the measurement set-up mount and the tool holder mount in the automatic lathe, the bore quality of the guide bush holding the bar stock, as well as the true position of the guide bush centreline which varies with each start-up of the machine.

In automatic lathes, this guide bush directs and precisely defines the position of the bar stock. These alignment errors are within an approximate bandwidth of 15 μm to 20 μm and, consequently, lead to rapid tool wear, greater machining forces which are very detrimental for small diameter workpieces, larger boring diameters than the diameter of the drill, as well as poor repeatability of machining dimensions.

The present invention proposes a new device for presetting the position of cutting tools or end tools. This new optical device for presetting cutting tools or end tools enable the alignment and referencing of tools in relation to the axis of the guide bush of an automatic lathe, particularly one with a moving headstock, directly in the machine. The invention thus aims to offer the possibility of avoiding tool alignment errors in relation to the axis of the guide bush, irrespective of whether the automatic lathe has a moving or fixed headstock.

### DESCRIPTION OF THE INVENTION

Generally, the invention proposes a new optical device for presetting cutting tools or end tools, wherein at least one part capable of transmitting images, by virtue of its design and construction, i.e. by virtue of its embodiment, can be introduced into a guide bush holding the bar stock in an automatic lathe, particularly one with a sliding headstock. This part of the device is held in the guide bush by the collet or workholder of the headstock. As the device is at least partially placed inside the guide bush, it enables simultaneous visualisation of the diameter of the pilot bore and the tool, either the cutting tool or the end tool, which will have been pre-positioned on the front of the guide bush.

This optical device is used for acquiring images by a computer and on a display screen, which will enable the operator to take reference coordinates and to align the tool relative to the bore diameter of the guide bush in an automatic lathe. A circular array of light-emitting diodes (LED) is installed in front of the guide bush to obtain optimum illumination.

In its general embodiment, the optical device for the positioning adjustment of cutting tools or end tools of an automatic lathe relative to the central bore axis of the guide bush holding the workpiece, which is the subject of the invention, is characterised in that it includes at least one camera equipped with at least one extension tube fitted with at least one lens and capable of being placed in the guide bush, in such a way that said extension tube is directed towards the cutting tool or tools or end tool or tools, the camera also being fitted with the means of transmitting the image of the opening of said guide bush in the direction of said cutting tool or tools or end tools and the image of the part of said cutting tools or end tools visible through the opening of the guide bush.

In a first special embodiment of the invention, the device is characterised in that the extension tube includes at least one gradient index lens.

In a second special embodiment, applicable to the two preceding special embodiments, the device is characterised in that it comprises at least one achromatic lens placed between the extension tube and the camera.

In a third special embodiment, applicable to the three preceding special embodiments, the device is characterised in that the camera is fitted with a CCD sensor.

In a fourth special embodiment, applicable to the four preceding embodiments, the device is characterised in that it comprises the means enabling the camera to move in the direction of the axis of the lens mount.

In a fifth special embodiment, applicable to the five preceding embodiments, the device is characterised in that it comprises a computer to which the image of the guide bush opening and of the part of the end tools or cutting tools visible through this opening is transmitted, said computer being programmed in such a way as to enable the registering of the position of at least one reference point from the image of said opening of the bush and to cause said point to appear on a screen, thus enabling the positioning of tools in relation to said reference point.

In a sixth special embodiment, applicable to the preceding special embodiment, the device is characterised in that the reference point coincides with the central axis of the guide bush.

In a seventh special embodiment, applicable to the two preceding special embodiments, the device is characterised in that the computer is programmed so as to display a pattern on the screen comprising two orthogonal axes forming a Cartesian coordinate system.

In a eighth special embodiment, applicable to the seventh special embodiment, the device is characterised in that the computer is programmed to register and/or display the position of the cutting edge of at least one cutting tool according to the Cartesian coordinate system.

In an ninth special embodiment, applicable to the preceding embodiments, the device is characterised in that the computer is programmed to register and/or display the position of the rotary axis of at least one end tool, particularly a drill, according to the Cartesian coordinate system.

In a tenth special embodiment, applicable to the preceding fifth to ninth special embodiments, the device is characterised in that the reference point is the centre of a circle the circumference of which is positioned so as to be tangential to or superposed on the arcs of circles formed by the image of the internal surface of the jaws of the guide bush workholder.

In an eleventh special embodiment, applicable to the tenth special embodiment, the device is characterised in that the reference point is the origin of the Cartesian coordinate system.

In a twelfth special embodiment, applicable to the general embodiment and to the first to eighth embodiments, and the tenth and eleventh embodiments above, the device is characterised in that it comprises illumination by a set of light-emitting diodes placed behind the cutting tool or tools in relation to the camera.

In a thirteenth special embodiment, applicable to the ninth embodiment above, the device is characterised in that it comprises illumination by light-emitting diodes, each diode being placed on a plane perpendicular to the central bore axis of the guide bush, said plane being located in front of the end tool in relation to the camera.

In a fourteenth special embodiment, applicable to the preceding special embodiments, the device is characterised in that the internal surfaces of the extension tube, lens mount, and camera housing are treated so as to minimise internal reflections.

In a fifteenth special embodiment, applicable to the preceding embodiment, the device is characterised in that the surface treatment is anodisation.

In a sixteenth special embodiment, applicable to the preceding embodiments, the device is characterised in that it comprises at least one guide sleeve capable of encircling the end of the extension tube, the external diameter of which corresponds to the bore defined by the jaws of the guide bush workholder.

### BRIEF DESCRIPTION OF THE DRAWINGS

FIG. 1 is a longitudinal section of a device according to the invention, wherein the guide bush and workholder are represented schematically, showing the extension tube of the camera inserted into said bush, but without a guide sleeve. The guide bush workholder is not shown.

FIG. 2 is a longitudinal section of a device according to the invention in a slightly different embodiment from that of FIG. 1, wherein the camera is larger and before the introduction of the extension tube in the bore of the guide bush, the extension tube carrying a guide sleeve and a cutting tool positioned in front of the opening of said bore.

FIG. 3 is a longitudinal section of a device according to the invention in the same embodiment as that in FIG. 1, but wherein the guide bush workholder is shown while the body of the guide bush itself is not shown. The extension tube, fitted with a guide sleeve, is introduced into the bore of the guide bush, an end tool, which here is a drill, being placed in front of the opening of said bore.

FIG. 4 is an image of the inside of the guide bush towards to its opening, in the direction of the tool to be positioned, such as is transmitted to the camera by the extension tube, and wherein the dotted lines show the three line segments linking the two angles of each of the three jaws of the guide bush workholder.

FIG. 5 is the same image as that of FIG. 4, but wherein is shown the reference point which is at the centre of the guide bush, whose position has been acquired according to the three line segments linking the two angles of each of the jaws of the guide bush workholder, said line segments no longer shown and the reference point constituting the origin of a Cartesian coordinate system, a cutting tool, shown, with the dotted line segments running parallel to the sides of the edge of said tool determining the position of this edge at their intersection.

FIG. 6 is the same image as that in FIG. 5, the difference being that the cutting tool is replaced by an end tool, such as a drill, and the line segments no longer shown, while the visible circumference of the end tool is surrounded by a circle centred at the origin.

### BEST MANNER OF IMPLEMENTING THE INVENTION

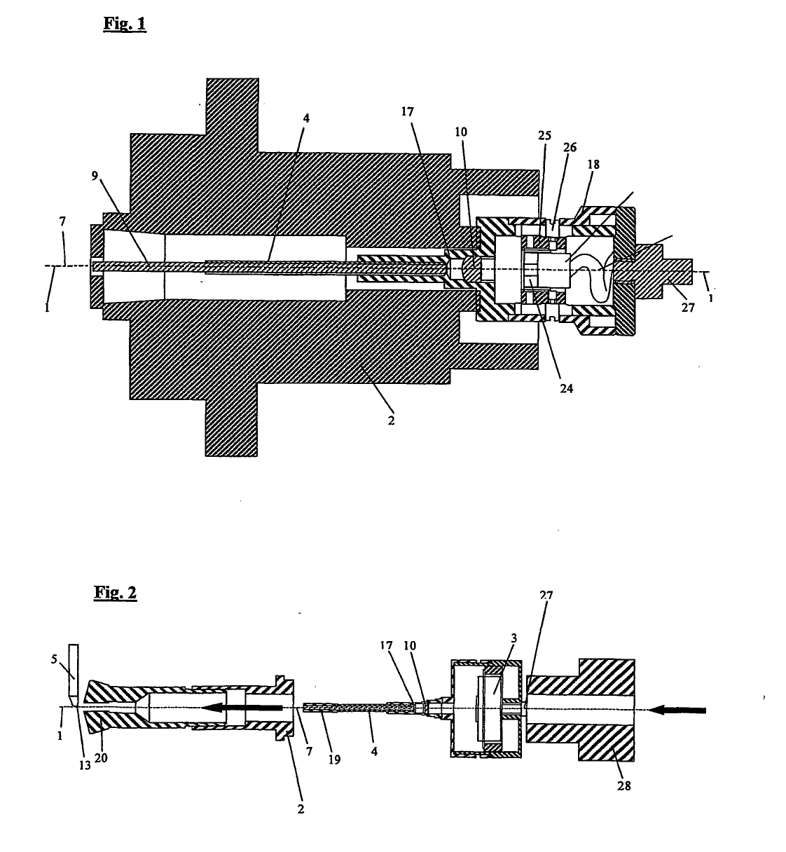

The best embodiment of the device according to the invention is that shown in FIGS. 1 and 3 to 6. This device preferably comprises a miniature CCD camera 3 fitted with an extension tube 4. This extension tube is equipped with one or several lenses, of which one 9 is a gradient-index lens. The extension tube 4 is fixed on a set of lenses 17 comprising at least one achromatic lens 10.

The camera 3 is inserted in a housing 18 and its axis corresponds to the axis 7 of the lens mount, which itself coincides, once the optical assembly is introduced into the guide bush 2, with the central axis 1 of said bush. The camera is fixed on an internal ring 24, which is mounted in a part 25 inserted into the housing 18. The assembly formed by the camera 3, the ring 24 and the part 25 can slide longitudinally in the direction of the axis 7 of the lens mount, and consequently in the direction of the central axis 1 of the guide bush. The displacement is guided by two cheese-head screws 26. The axial displacement of the camera enables the operator to adjust the clarity of the image. A set of lenses 17 is attached to the housing 18, shown here in the form of a cylindrical part wherein the part adjacent to the housing 18 has a greater diameter than the part further away from said box.

The part of the greater diameter cylindrical part 17 contains the achromatic lens 10, while the smaller diameter part contains the extension tube 4 wherein the gradient-index lens 9 is placed. This gradient-index lens is specially designed for imaging. The assembly formed by the camera 3, the housing 18 and the set of lenses 17, including the extension tube 4 and the gradient-index lens, once introduced into the guide bush, is held by the headstock 28 by means of a fixing end piece 27 fixed behind the housing 18 and which is gripped and held in place by the headstock workholder.

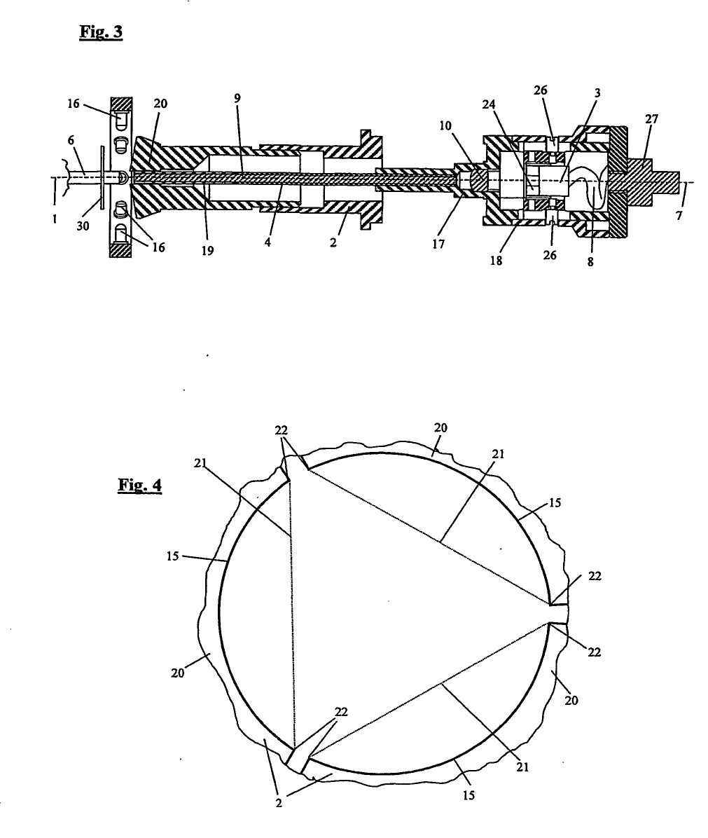

At the face of the guide bush, the tool or tools to be positioned are in place. In FIG. 2, the tool is a cutting tool 5, shown here in the form of an insert. In FIG. 3, the tool is an end tool 6, shown here in the form of a drill. FIG. 2 does not show how the cutting tool 5 is illuminated. In the case of cutting tools, lighting comes from behind such that the cutting tool 5 appears against the light in the guide bush opening. The edge 13 of the tool thus appears as a sort of shadow, as shown in FIG. 5. This back lighting is provided by a series of white light-emitting diodes fixed on a plate which is placed on the counter-spindle facing the guide bush. This illuminating device is not shown in the drawings. Conversely, for end tools, FIG. 3 shows a circular array carrying a series of light-emitting diodes 16. The circular array is placed at the face of the guide bush, before the drill. This is equipped with a disk 30, preferably of a light colour, which is fitted perpendicularly on the drill, in the centre thereof, thereby reflecting light, such that the circumference of the drill appears clearly in the guide bush opening.

The outside diameter of the extension tube is small enough to allow its introduction into the bore of the guide bush 2.

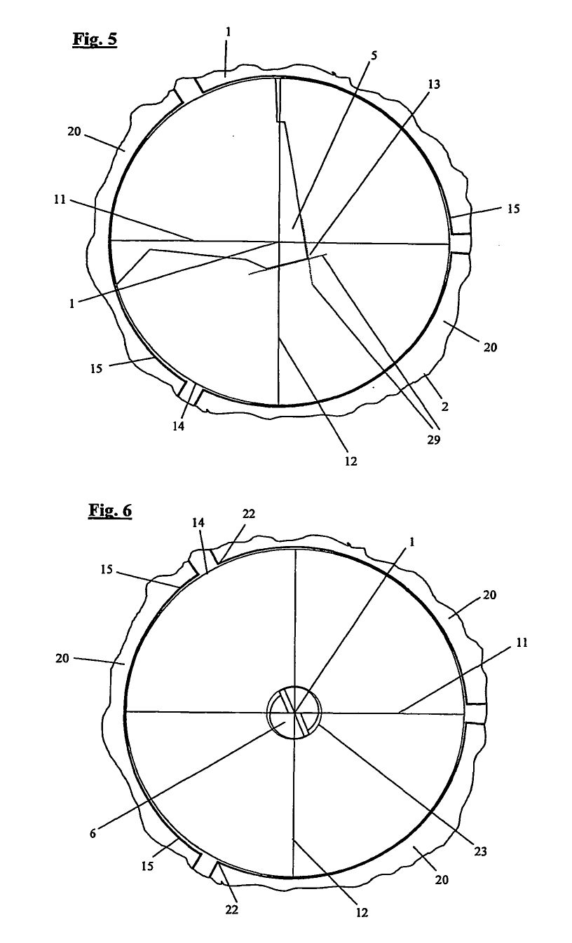

The end of the extension tube is fitted with a guide sleeve 19. This consists of a simple hollow cylinder, whose outside diameter corresponds to the bore of the guide bush, which surrounds the end of the extension tube 4. This sleeve enables the extension tube to be centred as precisely as possible in the guide bush thereby avoiding image distortions which could occur in the event of poor centering, such distortions could lead to measurement inaccuracy. In practice, the device should be delivered with a series of sleeves of varying diameters, which correspond to the usual bore diameters on the market. The lens or lenses 9 of the extension tube acquire the image of the guide bush opening in the direction of tools 5 or 6, as well as the image of the part of the tools which appear in this opening. The image is transmitted to the achromatic lens 10 and then passes into the camera 3, which then passes it from its CCD sensor to a computer, not shown in the drawings, via a cable 8. This computer is programmed such as to enable the operator to find the centre of the circle formed by the image of the opening of the bush, the centre corresponding to the position of the bore axis 1 of the guide bush 2. Acquisition of the position of this centre, which is the reference point, is carried out as follows: on the image of the opening of the guide bush which appears on the computer screen, the operator draws a line segment 21 between the two angles 22 of one of the workholder jaws 20. The characteristics of this segment 21 are recorded in the computer. The operator then proceeds in the same manner for the two other workholder jaws. The computer, which is programmed to this effect, then calculates the position of the centre of the guide bush bore and shows it on the screen, in the centre of a circle 14 which coincides with the circle formed by the image of the bore opening. It should be noted here that the verb “coincide” should be understood in an approximate sense, since the three workholder jaws only form a real circle in one very precise clamping position—as is shown in FIGS. 5 and 6—in most cases, the three jaws are at such a distance from the centre that the three arcs of the circle 15 that they form can only be tangential to a circle through the centre of which the axis of the guide bush passes. The computer also shows two orthogonal straight lines 11 and 12 which cross in the centre thus defined, so constituting a Cartesian coordinate system wherein the origin is the centre of the image of the opening of the guide bush, which coincides with the axis 1 of the guide bush.

The operator can then proceed to acquire the position of the tool in the Cartesian coordinate system thus obtained, and to measure and record the difference between the coordinates of this position and the coordinates of this same position in the coordinate system of the automatic lathe.

For the cutting tools, acquisition of the edge 13 of the tool 5 is carried out by the computer as follows: the computer is programmed to automatically enter the position of the intersection of the two straight lines each of which is superimposed on one of the segments that forms the image of the edge on the screen. The dotted segments 29 in FIG. 5, show how the computer shows this intersection. Once acquired, the coordinates of this intersection point within the system are recorded in the computer and compared with the coordinates of this same intersection point, i.e. of the edge 13 of the tool, in the coordinate system of the automatic lathe. The tool is then displaced along the X-axis, and the X coordinate of this new position is recorded, which is compared with the X coordinate in the automatic lathe system. The same procedure is then carried out for a displacement along the Y-axis. In this manner, the computer records the differences between the coordinates of the position of the cutting edge of the tool according to the system created from the data relayed by the camera which is centred on the axis of the guide bush and the coordinates of the automatic lathe system. The offset can thus be corrected, either automatically by programmed control, or manually by adding the differences (negative or positive).

For end tools, the position of the tool centre cannot be acquired in the same way. The computer is programmed to show a second circle 23, smaller and concentric with the first circle 14, and centred like the one on the origin of the Cartesian coordinate system. The operator reduces the diameter of this circle such that it touches the perimeter of the image of the tool. The operator modifies the position of the tool and reduces the diameter of the circle 23, such as to reduce as much as possible the space between the circle and the perimeter of the image of the tool. The position of the centre of the circle according to the coordinates of the automatic lathe system is then recorded as well as the difference from the coordinates of the same position according to the system created on the basis of the camera data, and the offset is corrected to arrive at the desired position of the tool in relation to the axis of the guide bush.

### POSSIBILITIES FOR INDUSTRIAL APPLICATION

The invention is applicable to automatic lathes in the extensive field of bar turning.

1. Process for the optical adjustment of the position of cutting tools (5) or end tools (6), relative to a central bore axis (1) of a guide bush (2) holding a workpiece on an automatic lathe, using at least one camera (3) placed on the said guide bush (2), capable of transmitting the acquired image, comprising the steps: equipping the camera (3) with at least one extension tube (4) fitted with at least one lens (9) and introducing at least the extension tube (4) into the bore of the guide bush (2) such that the said extension tube (4) is directed towards the cutting (5) or end (6) tool or tools such as to transmit to the camera the image of said guide bush (2) and the image of the part of said cutting tools or end tools that are visible through the opening of the guide bush.

2. Optical device for adjusting the position of cutting tools or end tools in relation to a central axis (1) of a bore of a guide bush (2) holding a workpiece in an automatic lathe for an adjustment process according to claim 1, comprising at least one camera (3) equipped with at least one extension tube (4) fitted with at least one lens (9), said extension tube capable of being placed in the bore of a guide bush (2) such that said extension tube (4) is directed towards a cutting (5) or end (6) tool or tools, the camera (3) also being fitted with means (8) for transmitting the image of the opening of said guide bush (2) and the image of the part of said cutting tools or end tools that is visible through the opening of the guide bush and a computer to which the image of the opening of the guide bush (2) and the part of the cutting tools (5) or end (6) tools visible through this opening is transmitted, said computer being programmed such as to enable the recording of the position of at least one reference point from the image of said opening of the bush and to show said point on a screen, thereby enabling the positioning of the tools in relation to said reference point.

3. Device according to claim 2, wherein the extension tube (4) comprises at least one gradient-index lens (9).

4. Device according to claim 2, including at least one achromatic lens (10) placed between the extension tube and the camera.

5. Device according to claim 2, wherein the camera is fitted with a CCD sensor.

6. Device according to claim 2, including means enabling displacement of the camera (3) in the direction of the axis (7) of the lens mount.

7. Device according to claim 2, wherein the reference point coincides with the central axis (1) of the guide bush.

8. Device according to claim 2, wherein the computer is programmed so as to display on screen a pattern comprising two orthogonal axes (11, 12) forming a Cartesian coordinate system.

9. Device according to claim 8, wherein the computer is programmed to register and/or display the position of the cutting edge (13) of at least one cutting tool (5) according to the Cartesian coordinate system.

10. Device according to claim 2, wherein the computer is programmed to register and/or display the position of the rotary axis of at least one end tool (6), according to the Cartesian coordinate system.

11. Device according to claim 2, wherein the reference point is the center of a circle (14) positioned such as to be tangential to or superimposed on arcs of a circle (15) formed by the image of the internal surface of the jaws (20) of the guide bush workholder.

12. Device according to claim 11, wherein the reference point is the origin of the Cartesian coordinate system.

13. Device according to claim 2, including illumination by light-emitting diodes (16) placed behind the cutting tool or tools (5) in relation to the camera.

14. Device according to claim 10, including illumination by light-emitting diodes, each diode being placed on a plane perpendicular to the central bore axis (1) of the guide bush, the said plane being in front of the end tool (6) in relation to the camera.

15. Device according to claim 2, wherein the internal surfaces of the extension tube (4), the set of lenses (17) and the housing (18) of the camera (3) are treated so as to minimise internal reflection.

16. Device according to claim 15, wherein the surface treatment is anodisation.

17. Device according to claim 2, including at least one guide sleeve (19) capable of encircling the end of the extension tube (4), the outside diameter of said guide sleeve corresponding to the bore defined by workpiece holding jaws (20) of the guide bush workholder (2).
